(19) United States
(12) Patent Application Publication
(10) Pub. No.: US 2005/0129817 A1
(43) Pub. Date: Jun. 16, 2005

(54) Method of producing cereal clusters

(76) Inventors: Peter Malecha, Fairmont, MN (US); Hal Volkmann, Mankato, MN (US); Brent Bussinger, Blue Earth, MN (US); Dave Langford, Winnebago, MN (US); Travis Malo, Fairmont, MN (US)

Correspondence Address: CHOATE, HALL & STEWART LLP, EXCHANGE PLACE, 53 STATE STREET, BOSTON, MA, 02109, US

(21) Appl. No.: 10/972,991

(22) Filed: Oct. 25, 2004

Related U.S. Application Data
(60) Provisional application No. 60/514,257, filed on Oct. 24, 2003.

(51) Int. Cl. A23L 1/10

(52) U.S. Cl. 426/453

(57) ABSTRACT

The method of the present invention produces an edible, homogeneous cluster of a desired size and integrity. The clusters are prepared from various food particles including, but not limited to, flaked cereal, extruded cereal, grains, nuts, fruits, micronutrients, mineral and legumes. Food particulates are placed with a high brix binder into a high-speed vertical stator former. Cluster formation is accomplished within approximately 30 seconds to 2 minutes.

### PRIORITY INFORMATION

This application claims priority to Provisional Application No. 60/514,257 filed on Oct. 24, 2003.

### FIELD OF INVENTION

The present invention is directed towards a method of producing cereal clusters used in cereal, bar, dessert, and other food items.

### BACKGROUND OF INVENTION

Conventional methods used to produce cluster type products rely on older technologies utilizing mixers, horizontal coating/enrobing drums and large scale multiple dryers. Typically the older systems require premixing of the dry ingredients such as cereal, grains, nuts, legumes and depositing them in a horizontal coating drum to which a binder syrup is added. This large mass is then dried to remove the water from the mix and the product is sized to produce particles typically from 0.10″ to 0.50″ in diameter.

In view of the prior art, there is a continuing need for new and more efficient methods to produce such food products. Accordingly, in one aspect, the present invention provides a method of producing food type clusters in a more efficient manner than is presently available. In another aspect, the present invention provides an economic method of producing customized food products employing various nutritional value added ingredients.

### SUMMARY OF INVENTION

Clusters may be produce in a more efficient manner requiring less time than the typical coating, long drying and sizing methods of current drum mixing and trying technology of the prior art. In one aspect, the method of the present invention provides for rapid cluster formation of clusters between 0.10″ and 1.0″ in size, without further processing to obtain such size. In one embodiment, the method provides for little moisture to be removed from the cluster in the drying process. In another embodiment, not more than 3-8% moisture needs to be removed from the cluster during the drying process of the present invention.

The clusters of the present invention are not limited to cereal applications, but may also be customized for use in dessert items, cereal bar applications and any other food item where a customized cluster of various size and texture is required for differentiation.

The clusters provided by the method of the present invention are prepared from various food particles including, but not limited to, flaked cereal, extruded cereal, grains, nuts, fruits, micronutrients, mineral and legumes. Food particulates are placed with a high brix binder into a high-speed vertical stator former. In certain aspects, the speed of the unit, syrup brix and food ingredients forms the clusters to the desired size of 0.10 to 1.0 inches in diameter in 30 seconds to 2 minutes. In one aspect, the product is the desired size and shape as it exits the stator former. In yet another aspect, the product is dried in a simple bed dryer and is packaged.

### BRIEF DESCRIPTION OF THE DRAWING

FIG. 1 is a flow diagram of a stator former process of producing clusters.

### DETAILED DESCRIPTION OF THE DRAWING

The method of the present invention produces an edible, homogeneous cluster of a desired size and integrity. In one embodiment, the cluster exits the stator former ready for drying and packaging.

Granular Ingredients

Granular ingredients are comprised of, but are not limited to, cereal grains, cooked cereal, nuts and other food particulates. In one aspect, the granular ingredients form 50-80% of the agglomerate or cluster.

Nuts

In another aspect, the nut portion of the agglomerate promotes cluster forming of the ideal clusters between 0.25 to 1.0 inches when sized so that 100% passes through a U.S. 0.5 inch Standard Screen and 100% is held from passing through a U.S. # 16 Standard Screen. The nut pieces may be selected from nut meal, meeting the above screen specifications, or ground nuts, such as almonds, Brazilian nuts, walnuts, peanuts, pecans or mixtures thereof.

Cereal Grains and Cooked Cereal

Cereal grains may be prepared with flaked/bumped wheat, corn, barely, or oats with or without the bran layer. Flaked/bumped grains are obtained by: soaking the grains in water, steaming or partially cooking the grains; tempering the grains; and flaking the grains.

In another embodiment, the cooked cereal is composed of flours of grain, protein, bran or other additives that have been cooked, flaked, formed or extruded and dried. Whole cooked and puffed cereal grains, produced from either batch cooking, flaking and puffing grains such as rice, or gun puffed grains may also be used.

In one aspect, the cereal pieces (grains or cooked) perform optimally for the cluster diameter of 0.25 to 1.0 inches when sized so that 100% passes through a U.S. 0.5 inch Standard Screen and 100% is held from passing through a U.S. # 16 Standard Screen.

Fruit may be substituted for a portion of the cereal, nut or other food particulate portions of the mix.

Micro Ingredients

Micro ingredients are comprised of, but are not limited to, sodium bicarbonate, calcium carbonate, soluble fiber, insoluble fiber, protein concentrates or protein isolates. In one aspect, micro ingredients form 1-30% of the end-product agglomerate.

Binder Ingredients

Binder ingredients are comprised of, but are not limited to, brown sugar, liquid turbinado, dried turbinado, powdered sugar, granulated sugar, corn syrup, honey, salt, flavoring, water, sugar alcohol or mixtures or equivalents thereof. In one aspect, binder ingredients form 20-50% of the agglomerate or cluster.

Methodology

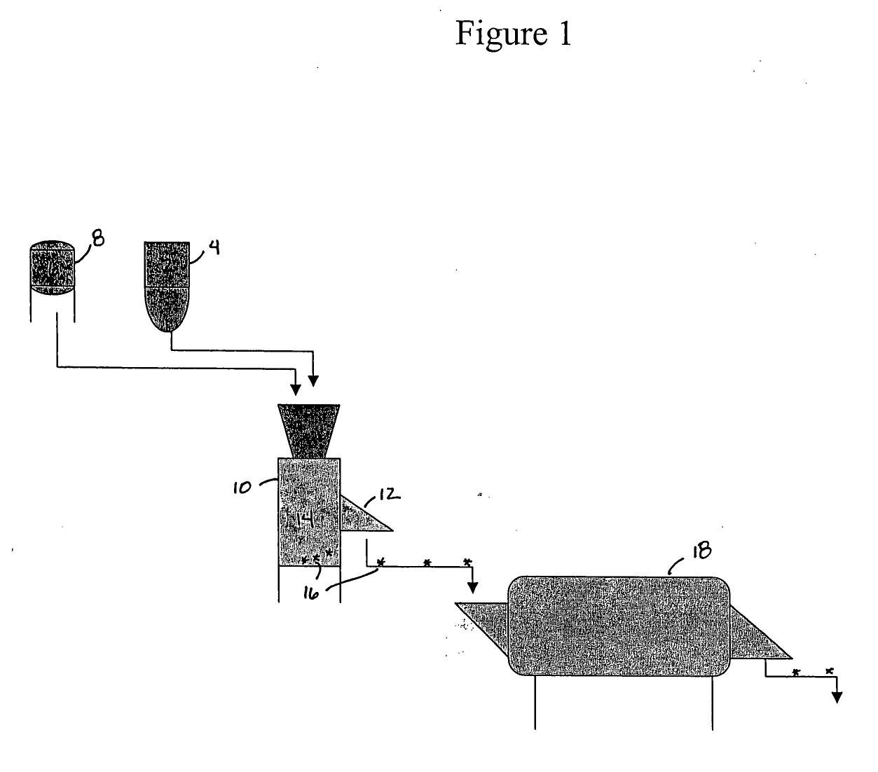

One embodiment of the stator cluster former process is shown in FIG. 1. Preparation of the granular ingredients 2 is accomplished in a first container 4 by mixing the cereal grains, cereal, nut meals and other food particulates in a ratio of 40-100% cereals and 0-60% nuts. Other food particulates may be substituted for the cereal or nut portions partially or in full.

Preparation of the binder solution 6 is accomplished in a second container 8 by mixing up the ingredients noted under the binder section (above) and heating this mixture to achieve a syrup brix between 70-95, with an ideal of approximately 85 brix.

The stator former equipment 10 is set to achieve a rotor tip (not shown) speed of 15-20 feet per second. This is typically 300-400 rpm on a 11.5 inch model. In one aspect, the release gate 12 is closed. In another aspect, the stator former does not have a release gate, and utilizes other mechanisms for expelling clusters from its housing.

The binder mix 6 is cooled to a temperature of 150-220 degrees Fahrenheit with the ideal temperature at 190 degrees Fahrenheit for cluster forming.

Granular mix 2 is supplied to the stator former 10. The ratio of granular mix 2 to binder syrup 6 is between 50-80% granular mix 2 to 20-50% binder mix 6.

Binder mix 6 is supplied to the stator former 10. In one embodiment, the duration of time for the binder mix 6 to be supplied to the stator former 10 is between 15-30 seconds for the 11.5 inch model of stator former 10. Time duration may reach 2 minutes for lower brix binder mixes.

As the syrup 6 is added, the spinning internal rotor (not shown) agitates the combined mix 14 to the stator walls, which performs a rolling motion causing the mix 14 to form into clusters 16. Cluster 16 formation usually occurs within 30-45 seconds of binder 6 addition.

If additional micro mixes (not shown) are required, they may be added immediately after the addition of the syrup 6.

After cluster 16 formation, the release gate 8 is opened and the clusters 16 are expelled from the stator 10 housing by the spinning action of the internal rotor. Unlike conventional drum technology, the expelled product 16 from the stator former 10 is of such homogeneous mixture, integrity and strength that it may be conveyed to a dryer 18 by either air conveyance systems, vibrating table conveyors or belt conveyors, without severe damage to the product 16.

The clusters 16 are dried in a conventional single pass drying unit or multiple pass drying unit. Drying time is from approximately 5-20 minutes at temperatures of approximately 200-250 degrees Fahrenheit with an exit moisture of approximately 2-7%.

### EXAMPLE

The invention is further described but not limited by the following example:

A granular mix is prepared as follow:

| | |
|---|---|
| Crisp rice cereal | 40.0% |
| Cocoa crisp rice cereal | 20.0% |
| Sized almonds | 40.0% |
| Total | 100.0% |

Mix is weighed out and placed in an intermediate storage container for addition to the vertical stator former.

The binder mix is prepared as follows:

| | |
|---|---|
| Water | 9.5% |
| Brown sugar | 8.0% |
| Flavor | 1.0% |
| Corn syrup | 10.2% |
| Honey | 10.3% |
| Sucrose | 30.3% |
| Turbinado | 30.3% |
| Salt | 0.4% |
| Total | 100.0% |

The mix is heated until all the sugars are dissolved and a brix of 85 is obtained.

The vertical stator former is set to the following conditions prior to the granular mix being added to the unit:

| | |
|---|---|
| Rotor speed | 400 rpm |
| Rotor tip speed | 20 feet/second |
| Release gate | closed |

The heated binder syrup is cooled to 190 degrees Fahrenheit. The granular material and binder syrup are weighed out in the following ratio:

| | |
|---|---|
| Granular base ingredients | 65.0% |
| Binder syrup | 35.0% |
| Total | 100.0% |

The granular mix is added to the vertical stator former. The mix is put into a circular motion against the stator walls by the action of the rotor. As soon as this occurs, the binder syrup is added to the granular mix. For the 11.5 inch vertical former, this is an approximately 15 second pour time. The binder mix may be either poured or pumped into the chamber so long as the pour time remains constant for the size mix being produced. Cluster formation starts rapidly as the binder is added. Cluster formation is accomplished within 30 seconds to 2 minutes. As the clusters form, the exit gate is opened and the product is expelled onto the conveyor for drying.

The formed clusters are of such size and strength that they are in the finished form as they leave the vertical stator former. The only further action required is the removal of the residual moisture from the binder portion. Typically no more than 3-8% of moisture needs to be removed. As the product exits the dryer, it is ready for packaging or addition to other products.

1. A method of producing food clusters comprising:
preparing a granular mix by combining cereal grains, cereal, nut meals and other food particulates in a ratio of approximately 40-100% cereals and approximately 0-60% nuts;
preparing a binder mix to bind with the granular mix, by combining binder ingredients and heating said combined ingredients to achieve a syrup brix between approximately 70-95 brix;
providing a stator former, wherein the stator former has a release gate;
setting the stator former to achieve a rotor tip speed of approximately 15-20 feet per second;
cooling the binder mix to a temperature between approximately 150-220 F.;
supplying the granular mix to the stator former;
supplying the binder mix to the stator former; and
mixing the granular mix and binder mix in the stator former.

2. The method of claim 1, wherein the food clusters are approximately 0.10 to 1.0 inches when sized.

3. The method of claim 1, wherein the granular mix forms approximately 50-80% of the food cluster.

4. The method of claim 1, wherein the nut portion of the granular mix is approximately between 0.25 to 1.0 inches when sized.

5. The method of claim 1, wherein the nut portion of the granular mix is sized so that 100% passes through a U.S. 0.5 inch Standard Screen and 100% is held from passing through a U.S. #16 Standard Screen.

6. The method of claim 1, wherein nut pieces of the nut portion of the granular mix are selected from a group consisting of almonds, Brazilian nuts, walnuts, peanuts, pecans and mixtures thereof.

7. The method of claim 1, wherein cereals are cereal grains.

8. The method of claim 1, wherein cereals are selected from a group consisting of flaked wheat, bumped wheat, corn, barely, oats with a bran layer and oats without a bran layer.

9. The method of claim 1, wherein cereals are cooked cereals.

10. The method of claim 1, wherein cereals are composed of flours of grain, protein, bran or other additives that have been cooked, flaked, formed or extruded and dried.

11. The method of claim 1, wherein cereals are selected from a group consisting of whole cooked cereal grains, puffed cereal grains, flaking grains, puffing grains, rice and gun puffed grains.

12. The method of claim 1, wherein the cereal portion of the granular mix is sized so that 100% passes through a U.S. 0.5 inch Standard Screen and 100% is held from passing through a U.S. #16 Standard Screen.

13. The method of claim 1, wherein fruit is substituted for at least a fraction of the cereal, nut or food particulate portion of the granular mix.

14. The method of claim 1, further comprising:
supplying micro ingredients to the stator former; and
mixing the granular mix, binder mix and micro ingredients in the stator former.

15. The method of claim 14, wherein micro ingredients are selected from a group consisting of sodium bicarbonate, calcium carbonate, soluble fiber, insoluble fiber, protein concentrates and protein isolates.

16. The method of claim 14, wherein micro ingredients form approximately 1-30% of the food cluster.

17. The method of claim 1, wherein the binder mix is prepared by combining binder ingredients and heating said combined ingredients to achieve a syrup brix of approximately 85 brix.

18. The method of claim 1, wherein the binder ingredients of the binder mix are selected from a group consisting of brown sugar, liquid turbinado, dried turbinado, powdered sugar, granulated sugar, corn syrup, honey, salt, flavoring, water, sugar alcohol and equivalents thereof.

19. The method of claim 1, wherein the binder mix is cooled to a temperature of approximately 190 Fahrenheit.

20. The method of claim 1, wherein the binder mix forms approximately 20-50% of the food cluster.

21. The method of claim 1, wherein the stator former is an 11.5″ model.

22. The method of claim 1, wherein the barrel of the stator former is 11.5″ in diameter.

23. The method of claim 1, wherein the stator former achieves a rotor tip speed of approximately 300-400 rpm.

24. The method of claim 1, wherein the ratio of granular mix to binder mix supplied to the stator former is between approximately 50-80% granular mix to 20-50% binder mix.

25. The method of claim 1, wherein the duration of time for the binder mix to be supplied to the stator former is between approximately 15 seconds to 2 minutes.

26. The method of claim 1, wherein the duration of time for the binder mix to be supplied to the stator former is between approximately 15-30 seconds.

27. The method of claim 1, wherein the release gate of the stator former is closed while the granular mix and binder mix are supplied to the stator former.

28. The method of claim 1, wherein the release gate of the stator former is open after the granular mix and binder mix have been supplied to the stator former.

29. The method of claim 14, wherein the release gate of the stator former is closed while the micro ingredients are supplied to the stator former.

30. The method of claim 14, wherein the release gate of the stator former is open after the micro ingredients are supplied to the stator former.

31. The method of claim 1, further comprising:
expelling the food clusters from the stator former; and
conveying the food clusters to a dryer; and
drying the food clusters in a dryer.

32. The method of claim 31, wherein the food clusters are conveyed to a dryer by an air conveyance system.

33. The method of claim 31, wherein the food clusters are conveyed to a dryer by a vibrating table conveyor.

34. The method of claim 31, wherein the food clusters are conveyed to a dryer by a belt conveyor.

35. The method of claim 31, wherein the clusters are dried in a single pass drying unit.

36. The method of claim 31, wherein the clusters are dried in a multiple pass drying unit.

37. The method of claim 31, wherein drying time is approximately 5-20 minutes.

38. The method of claim 31, wherein the drying temperature is approximately 200- 250 Fahrenheit.

39. The method of claim 31, wherein the food clusters exiting from the dryer have an exit moisture of approximately 2-7%.

40. The method of claim 1 or 14, wherein the ingredients are supplied to produce customized products of various nutritional added ingredients.

41. A food cluster comprising:
a granular mix comprising cereal grains, cereal, nut meals and other food particulates in a ratio of approximately 40-100% cereals and approximately 0-60% nuts; and
a binder mix to bind with the granular mix, wherein the binder mix is prepared by combining binder ingredients and heating said combined ingredients to achieve a syrup brix between approximately 70-95 brix and then cooling the binder mix to a temperature between approximately 150-220 F.;
wherein the granular mix and binder mix are combined in a stator former.

42. An apparatus for producing food clusters comprising:
a stator former;
a first container for supplying a granular mix to the stator former; and
a second container for supplying a binder mix to the stator former.
